(19) United States
(12) Patent Application Publication
(10) Pub. No.: US 2026/0298099 A1
(43) Pub. Date: Oct. 1, 2026

(54) TURBINE ENGINE COMPONENT WITH A COOLING APERTURE

(71) Applicant: General Electric Company, Evendale, OH (US)

(72) Inventors: Emily Hope Davenport, Lone Tree, CO (US); Zachary Daniel Webster, Liberty Township, OH (US); Daniel Endecott Osgood, Loveland, OH (US); Michal Osusky, Rexford, NY (US); Ricardo Caraballo, Maineville, OH (US); Emma Grace Schuele, Cincinnati, OH (US); Evin Nathaniel Barber, Cincinnati, OH (US)

(21) Appl. No.: 19/578,108

(22) Filed: Mar. 25, 2026

Related U.S. Application Data
(60) Provisional application No. 63/777,106, filed on Mar. 25, 2025.
(60) Provisional application No. 63/777,096, filed on Mar. 25, 2025.

(51) Int. Cl. F01D 5/18

(52) U.S. Cl. CPC F01D 5/186; F05D 2260/202

(57) ABSTRACT

An engine component for a gas turbine engine, such as an airfoil rotatable about the engine centerline, includes an outer wall with a cooling aperture. The cooling aperture defines a cavity within the outer wall, and exhausting at a diffuser outlet to provide a cooling film over the outer wall. At least one metering hole fluidly couples the cooling aperture to an interior cooling circuit, where a cooling fluid flow is provided into the cooling aperture and then exhausts from the diffuser outlet.

### RELATED APPLICATION

This patent claims the benefit of U.S. Provisional Patent Application No. 63/777,106, titled “TURBINE ENGINE COMPONENT WITH A COOLING APERTURE,” which was filed on Mar. 25, 2025, and U.S. Provisional Patent Application No. 63/777,096, titled “TURBINE ENGINE COMPONENT WITH COOLING APERTURE,” which was filed on Mar. 25, 2025. U.S. Provisional Patent Application Nos. 63/777,106 and 63/777,096 are incorporated herein by reference in their entireties. Priority to U.S. Provisional Patent Application No. 63/777,106 and U.S. Provisional Patent Application No. 63/777,096 is hereby claimed.

### TECHNICAL FIELD

The present subject matter relates generally to a turbine engine component, such as an airfoil of a turbine blade assembly, having a cooling aperture architecture for cooling the turbine engine component.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited to generate hot combustion gases. The combustion gases are channeled to the turbine(s) which extracts energy from the combustion gases for powering the compressor(s), as well as for producing useful work to propel an aircraft in flight or to power a load, such as an electrical generator.

During operation of the gas turbine engine, various systems may generate a relatively large amount of heat. For example, a substantial amount of heat may be generated during operation of the thrust generating systems, lubrication systems, electric motors and/or generators, hydraulic systems or other systems. Accordingly, a cooling structure within the engine components located in the various systems would be advantageous in the art.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a gas turbine engine, in accordance with an aspect of the present disclosure.

FIG. 2 is a perspective view of an engine component in the form of a turbine blade assembly having an airfoil utilized within the gas turbine engine of FIG. 1, with the airfoil including a cooling aperture, in accordance with an aspect of the present disclosure.

FIG. 3 is a perspective view of the turbine blade assembly of FIG. 2, with the cooling aperture shown as four cooling apertures illustrating various orientations and arrangements for the four cooling apertures, in accordance with an aspect of the present disclosure.

FIG. 4 is an enlarged schematic view of the cooling aperture of FIG. 2, including two metering holes, a first side, a second side, and a diffuser outlet, in accordance with an aspect of the present disclosure.

FIG. 5 is an enlarged schematic view of the cooling aperture of FIG. 4, illustrating dimensions of the diffuser outlet, the first side, and the second side, in accordance with an aspect of the present disclosure.

FIG. 6 is a side view of the first side for the cooling aperture of FIG. 4 illustrating a first angle of curvature for the first side, in accordance with an aspect of the present disclosure.

FIG. 7 is a side view of the second side for the cooling aperture of FIG. 4 illustrating a second angle of curvature for the second side, in accordance with an aspect of the present disclosure.

FIG. 8 is a cross-sectional view of a portion of an outer wall of the airfoil of FIG. 1 showing a cooling aperture, in accordance with an aspect of the present disclosure.

### DETAILED DESCRIPTION

Aspects of the disclosure generally relate to turbine engine components that utilize cooling, such as cooled turbine engine blades. Aspects of the disclosure relate to a cooling aperture for cooling the turbine engine component, with the cooling aperture providing greater producibility or manufacturability, as well as a higher coverage area for a provided cooling film.

Aspects of the disclosure herein are directed to a cooling aperture located within a turbine blade assembly. Specifically, aspects of the disclosure are directed to a cooling aperture exhausting onto an exterior of an airfoil of the turbine blade assembly proximate a tip of the airfoil. The performance of the cooling aperture is a function of geometric parameters that drive heat transfer, cooling film generation, and cooling fluid flow rate resultant of a cooling fluid passed through the cooling aperture.

In certain exemplary embodiments of the present disclosure, a gas turbine engine defining an engine centerline and a circumferential direction is provided. The gas turbine engine generally includes a rotor assembly and a stator assembly. The rotor assembly and the stator assembly collectively define a substantially annular flow path through the gas turbine engine.

The rotor assembly includes a set of blade assemblies. Each blade assembly is mounted to a rotor, such as to a turbine disk, by a shank, to affect rotation. The set of blade assemblies are distributed circumferentially about the engine centerline. The number of blade assemblies mounted to the turbine disk may vary.

The stator assembly includes a set of vane assemblies. The set of vane assemblies including airfoils mounted between inner and outer bands distributed circumferentially about the engine centerline. The set of vane assemblies also defines a set of nozzles. It is further contemplated that the set of vane assemblies may include a single pair of airfoils defining a single nozzle. In one implementation, the vanes are stationary and define the stator assembly.

It is further contemplated that in a counter-rotating engine, the vane assemblies are mounted to a rotating drum such that both the set of blade assemblies and the set of vane assemblies rotate.

Stress and high temperature can cause creep in the components of the gas turbine engine, such as the turbine blade assemblies. Additionally, fatigue in specific areas of the components can increase over time. Creep and fatigue may result in unintended engine removals that limit engine Time on Wing (TOW).

To mitigate creep and fatigue, as well as corrosion and oxidation, turbine blade assemblies typically include cooling networks formed within various parts of the turbine blade assembly for the flow of cooling fluid throughout. Cooling fluid is introduced to an interior of the blade assembly and fed to various locations including within an airfoil of the turbine blade assembly. Efficiently and effectively providing the cooling fluid to areas susceptible to creep and fatigue is necessary to increase TOW and life span of the blade assembly.

Facilitating heat transfer along areas near the tip and trailing edge of the airfoil can be particularly difficult, in addition to bridging cooling film gaps among nearby film holes in those areas. Such a difficulty is the result of relatively higher variability in flow components due to the vortex generated at the tip. Additionally, the airfoil typically thins nearer to the trailing edge, reducing usable cooling volume, space, or area of the airfoil. Such limited space is further limited by tip plenums typically utilized at the tip, making areas near both the trailing edge and the tip particularly difficult to effectively cool. Furthermore, manufacture of tip holes for cooling at the tip or trailing edge are difficult to produce at high yields. Limited space for at the tip and trailing edge regions, particularly where the two meet, requires greater design optimization to achieve high yield cooling hole structures.

In one aspect of the disclosure herein at least one cooling aperture for the airfoil can be designed for various flight conditions, including take off, descent, and idle. The objective, when designing an airfoil, is generally stated as satisfying a minimum heat transfer capability and minimum cooling film capability within an acceptable amount of cooling fluid flow or pressure across or within the airfoil. Key factors to consider include the available fluid volume, flow rate, and associated geometrical constraints for the at least one cooling aperture design and the operational limits of the gas turbine engine or the particular component.

The inventors determined multiple factors have an effect on durability of the blade assembly in an engine environment, such as a metering hole area (A₁), a diffuser outlet area (A₂), a diffuser outlet length (lₑ), a diffuser outlet vector length (l_{e,v}), a side angle (α), a first curvature angle (γ_{A}), and a second curvature angle (γ_{B}).

The metering hole area (A₁) of a cooling aperture corresponds to the minimum cross-sectional area of a metering hole that supplies cooling fluid flow to the cooling aperture. Where multiple metering holes are used, the metering hole area (A₁) of the cooling aperture is the sum of the minimum cross-sectional areas of the respective metering holes. The metering hole area (A₁) impacts how much cooling fluid flow is introduced to the cooling aperture and the rate at which the cooling fluid flow is flowing. Specifically, the geometry of the metering hole(s), such as shape and cross-sectional area, impacts how much cooling fluid flow is introduced to the cooling aperture, as well as spread of that cooling fluid flow within the cooling aperture.

The diffuser outlet area (A₂) is the area of the diffuser outlet (i.e., the opening) formed in the exterior surface of the airfoil. The diffuser outlet area (A₂) impacts an amount of spreading of the film exhausting from the cooling aperture through the diffuser outlet. Specifically, the diffuser outlet area (A₂) determines the flow rate for the cooling fluid flow exhausting the cooling aperture, which determines spread and flow of a cooling film developed over the blade assembly. The rates of cooling fluid flow defined by the metering hole area (A₁) determines the amount of flow volume available for exhausting from the cooling aperture over the diffuser outlet area (A₂).

The diffuser outlet length (lₑ) is the length of a curved line that is equidistance between the forward and aft edges of the diffuser outlet and extends between opposing ends of the diffuser outlet. The diffuser outlet length (lₑ), impacts the spread of cooling fluid flow exhausting the diffuser outlet as a cooling film. The greater the diffuser outlet length (lₑ), the greater the relative size for the diffuser outlet and therefore, the greater the relative size for the diffuser outlet area (A₂).

The diffuser outlet vector length (l_{e,v}) is the length or distance between the opposing ends of the diffuser outlet in a straight line. The diffuser outlet vector length (l_{e,v}) impacts the spread of cooling fluid flow exhausting the diffuser outlet as a cooling film. Specifically, the diffuser outlet vector length (l_{e,v}), with the diffuser outlet length (lₑ), determines the curvature for the diffuser outlet, which impacts directionality and amount of spread of the cooling fluid flow as a cooling film when exhausting from the diffuser outlet.

The side angle (α) is an angle between a first axis extending from a junction of the cavity to a first opposing end of the diffuser outlet and a second axis extending from the junction to a second opposing end of the diffuser outlet. The side angle (α) represents how much the cooling aperture expands or widens to distribute flow along the exterior surface of the airfoil.

The first curvature angle (γ_{A}) is an angle between the first axis and a projection of the first axis onto a virtual plane that extends through the junction. Similarly, the second curvature angle (γ_{B}) is an angle between the second axis and a projection of the second axis onto the virtual plane. The first and second curvature angles (γ_{A}, γ_{B}) generally represent the amount the cooling aperture curves from the portion that receives the cooling fluid from the metering holes to the diffuser outlet at the exterior surface. The first curvature angle (γ_{A}) and the second curvature angle (γ_{B}) impact the heat transfer within the cooling aperture, and impacts the angle at which the cooling fluid flow is exhausted from the diffuser outlet. A relatively greater angle for the first curvature angle (γ_{A}) and/or the second curvature angle (γ_{B}) generates greater heat transfer, with relatively greater movement along the curved surface for the cooling aperture. Too great of an angle for the first curvature angle (γ_{A}) and/or the second curvature angle (γ_{B}) results in too great of a cross-flow or shear for the cooling fluid flow exhausting from the diffuser outlet, which negatively impacts cooling film generation, and, therefore, must be balanced to maximize heat transfer while ensuring effective cooling film is generated.

The example turbine blade assembly disclosed herein includes a cooling aperture sized and angled specifically to ensure adequate cooling capabilities while also ensuring efficient cooling distribution and bridging cooling film gaps associated with traditionally spaced cooling holes. Additionally, the blade assembly provides for greater manufacturability, which increases yield and decrease manufacture costs and time.

These factors need to be balanced against stringent engine efficiency and spacing requirements. The blade assembly designs described herein reduce particulate accumulation. This reduction provides more efficient cooling which diminishes or eliminates the propensity for creep and fatigue, as well as corrosion and oxidation, and in turn increases durability of the blade assembly which will also increase the life of the blade.

The standard practice for solving the problem of bridging cooling film gaps has been to place more cooling holes closer together. However, such practices lead to reduced engine performance and less time-on-wing (TOW). Therefore, a solution with a greater benefit for systems that are used in existing engines is needed, without requiring redesign of related components.

Increasing size, utilizing stronger material, and/or providing additional cooling features combats centrifugal and thermal stresses. However, such changes lead to increased costs, system weight, overall space occupied by the blade, and performance loss.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

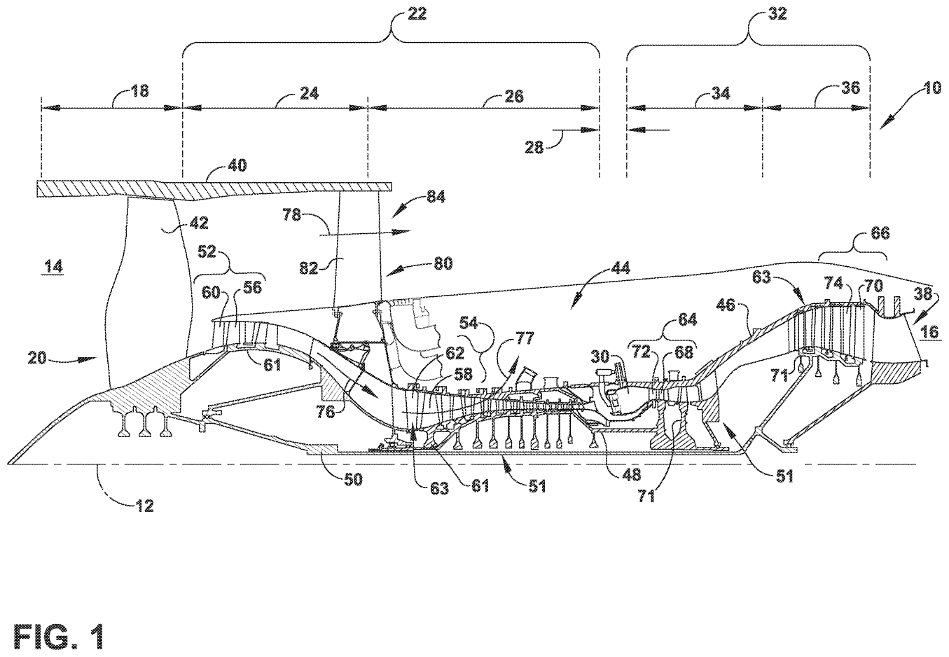

FIG. 1 is a schematic cross-sectional diagram of a gas turbine engine 10 for an aircraft. The gas turbine engine 10 has a generally longitudinally extending axis or centerline 12 extending from a forward 14 to an aft 16. The gas turbine engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including an HP turbine 34 and an LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the gas turbine engine 10, which generates combustion gases. The core 44 is surrounded by a core casing 46, which couples to the fan casing 40.

An HP shaft or spool 48 disposed coaxially about the centerline 12 of the gas turbine engine 10 drivingly connects the HP turbine 34 to the HP compressor 26. An LP shaft or spool 50 is disposed coaxially about the centerline 12 and positioned within the larger diameter annular HP spool 48. The LP shaft or spool 50 drivingly connects the LP turbine 36 to the LP compressor 24 and fan 20. The HP and LP spools 48, 50 are rotatable about the centerline 12 and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating compressor blades 56, 58. It is noted that the number of stages, blades, vanes, and compressor stages shown in FIG. 1 were selected for illustrative purposes only, and that other numbers are possible.

The compressor blades 56, 58 for a stage of the compressor can be mounted to a disk 61, which is mounted to the corresponding one of the HP and LP spools 48, 50, with each stage having a dedicated disk 61. In an alternative, non-limiting example, the compressor blades 56, 58 may be part of a blisk, rather than being mounted to a disk. The compressor vanes 60, 62 for a stage of the compressor can be mounted to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in an annular ring and can extend radially outwardly relative to the centerline 12, from a blade platform to a blade tip, while the corresponding static turbine vanes 72, 74 are positioned upstream of and adjacent to the rotating turbine blades 68, 70. It is noted that the number of stages, blades, vanes, and turbine stages shown in FIG. 1 were selected for illustrative purposes only, and that other numbers are possible.

The turbine blades 68, 70 for a stage of the turbine can be mounted to a disk 71, which is mounted to the corresponding one of the HP and LP spools 48, 50, with each stage having a dedicated disk 71. The turbine vanes 72, 74 for a stage of the turbine can be mounted to the core casing 46 in a circumferential arrangement.

Complimentary to the rotor 51, the stationary portions of the gas turbine engine 10, such as the static compressor and turbine vanes 60, 62, 72, 74 among the compressor and turbine sections 22, 32 are also referred to individually or collectively as a stator 63. As such, the stator 63 can refer to the combination of non-rotating elements throughout the gas turbine engine 10.

In operation, the airflow exiting the fan section 18 is split such that a portion of the airflow is channeled into the LP compressor 24 as a pressurized air 76, while a remaining portion bypasses the core 44 as a bypass airflow 78. The pressurized air 76 passes to the HP compressor 26, which further pressurizes the air. The pressurized air 76 from the HP compressor 26 is mixed with fuel in the combustor 30 and ignited, which generates combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the gas turbine engine 10 via the exhaust section 38. The driving of the LP turbine 36 drives the LP spool 50 to rotate the fan 20 and the LP compressor 24.

A portion of the pressurized air 76 can be drawn from the compressor section 22 as a bleed airflow 77. The bleed airflow 77 can be drawn from the pressurized air 76 and provided to engine components requiring cooling. The temperature of the pressurized air 76 exiting the combustor 30 is significantly increased. As such, cooling provided by the bleed airflow 77 bypassing the combustor 30 has a relatively cooler temperature, and can be supplied to downstream turbine components (e.g., the turbine blade 68) to cool those components subjected to the heightened temperature environments downstream of the combustor 30.

The bypass airflow 78 bypasses the LP compressor 24 and core 44 and exits the gas turbine engine 10 through a stationary vane row. The stationary vane row can be an outlet guide vane assembly 80 comprising a plurality of airfoil guide vanes 82 at a fan exhaust side 84. More specifically, a circumferential row of radially extending airfoil guide vanes 82 are utilized adjacent the fan section 18 to exert some directional control of the bypass airflow 78.

Some of the air supplied by the fan 20 can bypass the core 44 and be used for cooling of portions, especially hot portions, of the gas turbine engine 10, and/or used to cool or power other aspects of the aircraft upon which the gas turbine engine 10 is mounted. In the context of the gas turbine engine 10, the hot portions of the engine are normally downstream of the combustor 30, especially the turbine section 32, with the HP turbine 34 being the hottest portion as it is directly downstream of the combustion section 28. Other sources of cooling fluid can be, but are not limited to, the bleed airflow 77 from the LP compressor 24 or the HP compressor 26.

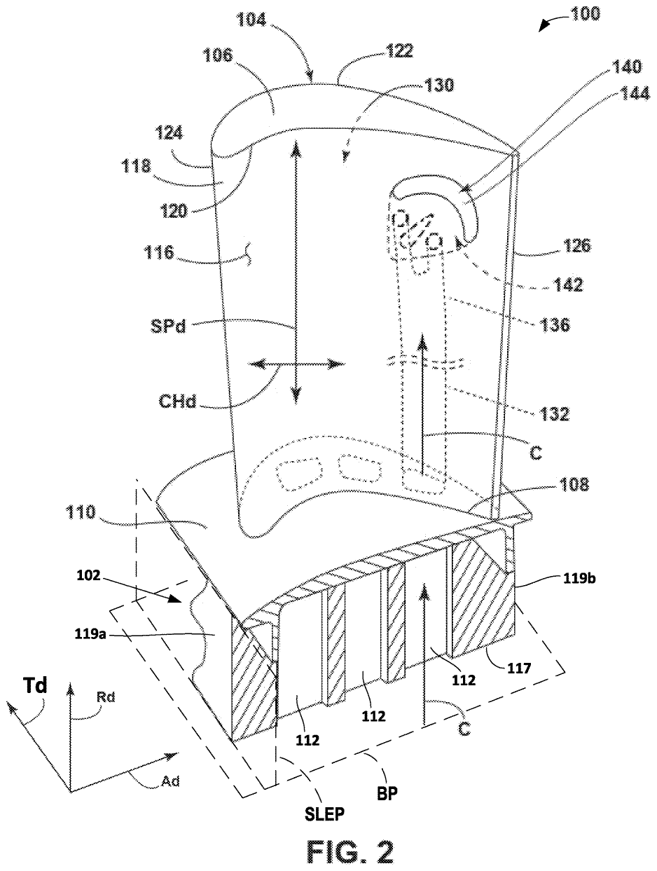

FIG. 2 is a perspective view of an engine component in the form of an a turbine blade assembly 100, such as the turbine blade 68, 70 of the gas turbine engine 10 from FIG. 1.

The turbine blade assembly 100 includes a shank 102, an airfoil 104, and a platform 110. The shank 102 is coupled to and extends from one side of the platform 110, and the airfoil 104 is coupled to and extends from the opposite side of the platform 110. The airfoil 104 includes a tip 106 and a root 108 that define a span-wise direction SPd extending therebetween. The airfoil 104 mounts to the platform 110 at the root 108. The shank 102 and the platform 110 are partially cross-sectioned in FIG. 2. When multiple airfoils are circumferentially arranged in side-by-side relationship, the platform 110 helps to radially contain the gas turbine engine mainstream airflow and forms the radially inner wall of an annulus through which the air flows. The shank 102 is configured to mount to the turbine rotor disk 71 (FIG. 1) on the gas turbine engine 10 (FIG. 1), in a non-limiting example. In the illustrated example, the shank 102 has a dovetail shape, which is shaped to be inserted into a corresponding slot in the disk 71. The shank 102 is oriented to mount to the turbine rotor disk 71 (FIG. 1) along an axial direction (Ad). The shank 102 further includes at least one inlet passage, shown as three exemplary inlet passages 112, extending through the shank 102 to provide internal fluid communication, such as a cooling fluid flow (C), with the airfoil 104. Such a cooling fluid flow (C), for example, can be the bleed airflow 77 of FIG. 1.

For the sake of reference, a set of relative reference directions, along with a coordinate system can be applied to the turbine blade assembly 100. The shank 102 extends between a base 117 and the platform 110. The base 117 of the shank 102 is a flat surface that defines a plane, referred to herein as the base plane (denoted “BP”). A radial direction (denoted “Rd”) of the turbine blade assembly 100 is a direction that is perpendicular to the base plane BP. Further, the shank 102 extends between a shank leading edge 119a and a shank trailing edge 119b. The shank leading edge 119a is a flat surface that defines a plane, referred herein as the shank leading edge plane (denoted “SLEP”). An axial direction (denoted “Ad”) of the turbine blade assembly 100 is a direction that is perpendicular to the shank leading edge plane SLEP. A tangential direction (denoted “Td”) is a direction perpendicular to both the radial direction Rd and the axial direction Ad.

The airfoil 104 includes an outer wall 118 having an exterior surface 116, which may be considered a hot surface. The exterior surface 116 includes a concave-shaped pressure side 120 and a convex-shaped suction side 122, which collectively define the airfoil cross-sectional shape. The airfoil 104 extends between a leading edge 124 and a trailing edge 126 to define a chord-wise direction CHd therebetween. The outer wall 118 defines an interior 130. The interior 130 includes at least one cooling circuit 132, illustrated in broken line, with the outer wall 118 having an interior surface 136 positioned adjacent the interior 130, which can be considered a cold surface arranged opposite of the relatively hotter exterior surface 116. The at least one cooling circuit 132 fluidly couples with the inlet passage 112 to receive the cooling fluid flow (C) within the interior 130 through the shank 102.

The airfoil 104 of the turbine blade assembly 100 includes a cooling aperture 140. The cooling aperture 140 is provided within the outer wall 118, and can be located along any portion of the outer wall 118. The cooling aperture 140 defines a cavity 142 in the outer wall 118 that exhausts at a diffuser outlet 144. The cooling fluid flow (C) is supplied from the at least one cooling circuit 132 to the cooling aperture 140. The cooling fluid flow (C) exhausts from the diffuser outlet 144 and spreads along the exterior surface 116.

Materials used to form the airfoil 104 and the cooling aperture 140, as well as the turbine blade assembly 100 or portions thereof, can include, but are not limited to, steel, refractory metals such as titanium, or superalloys based on nickel, cobalt, or iron, and ceramic matrix composites. The substrate and cooling architecture can be formed by a variety of methods, including additive manufacturing or additively enabled manufacturing, casting, or electroforming, in non-limiting examples. As used herein, an “additively manufactured” component will refer to a component formed by an additive manufacturing (AM) process, wherein the component is built layer-by-layer by successive deposition of material. AM is an appropriate name to describe the technologies that build 3D objects by adding layer-upon-layer of material, whether the material is plastic, ceramic, or metal. AM technologies can utilize a computer, 3D modeling software (Computer Aided Design or CAD), machine equipment, and layering material. Once a CAD model is produced, the AM equipment can read in data from the CAD file and lay down or add successive layers of liquid, powder, sheet material or other material, in a layer-upon-layer fashion to fabricate a 3D object representative of the CAD model. It should be understood that the term “additive manufacturing” encompasses many technologies including subsets like 3D Printing, Rapid Prototyping (RP), Direct Digital Manufacturing (DDM), layered manufacturing and additive fabrication. Non-limiting examples of additive manufacturing that can be utilized to form an additively-manufactured component include powder bed fusion, vat photopolymerization, binder jetting, material extrusion, directed energy deposition, material jetting, or sheet lamination. It is also contemplated that a process utilized could include printing a negative of the part, either by a refractory metal, ceramic, or printing a plastic, and then using that negative to cast the component.

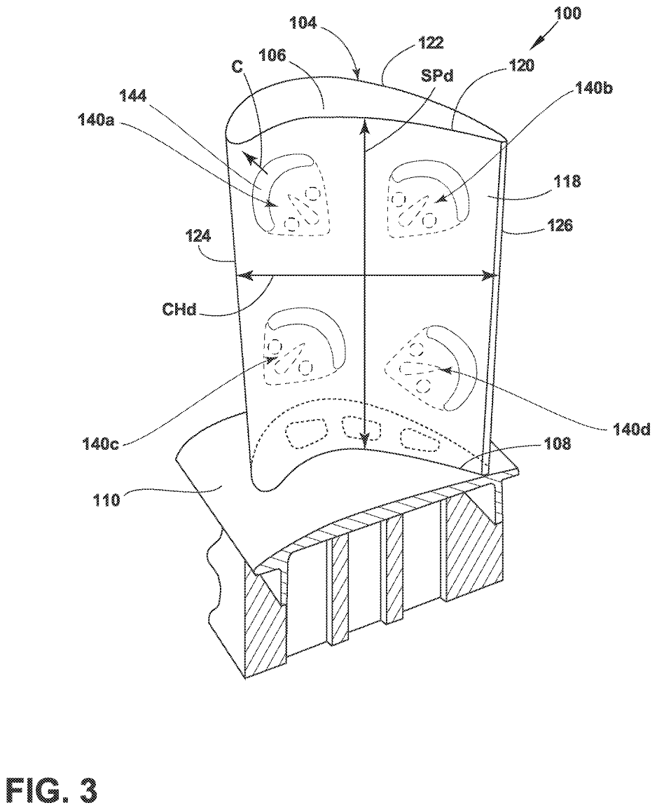

FIG. 3 shows an example of the airfoil 104 for the turbine blade assembly 100 having four cooling apertures 140a-d. As can be appreciated, the cooling apertures 140a-d can have any orientation. Furthermore, the cooling apertures 140a-d can be positioned at any portion of the airfoil 104 where heat transfer cooling and film cooling are desirable. The first cooling aperture 140a is arranged relatively nearer to the leading edge 124 and the tip 106, as compared with the remaining cooling apertures 140b-d. The orientation for the first cooling aperture 140a can be positioned such that the cooling fluid flow (C) exhausting from the diffuser outlet 144 is directed toward where the leading edge 124 meets the tip 106, while an orientation having the cooling fluid flow (C) toward the leading edge 124, the tip 106, or both, is contemplated. Similarly, the second cooling aperture 140b, similar to that shown in FIG. 2, is arranged relatively nearer to the trailing edge 126 and the tip 106, with an orientation toward where the trailing edge 126 meets the tip 106.

The third cooling aperture 140c is arranged relatively nearer to the leading edge 124 and the root 108. The third cooling aperture 140c is oriented away from where the leading edge 124 meets the root 108, where it is nearest, and is oriented toward where the tip 106 meets the trailing edge 126, similar to that of the second cooling aperture 140b. The fourth cooling aperture 140d is arranged relatively nearer to the trailing edge 126 and the root 108, with an orientation toward the trailing edge 126.

It should be appreciated that any orientation for the cooling aperture 140a-d is contemplated, such as an orientation toward one or more of the tip 106, the root 108, the leading edge 124, and the trailing edge 126. It should be further appreciated that any positioning for the cooling aperture 140a-d is contemplated, such as any position along the outer wall 118, as well as among either or both of the pressure side 120 and the suction side 122, as well as on the platform 110. That is, any orientation for the cooling aperture 140a-d having any position within the outer wall 118 is contemplated. Further orientation relative to the span-wise direction (SPd), the chord-wise direction (CHd), or both is further contemplated.

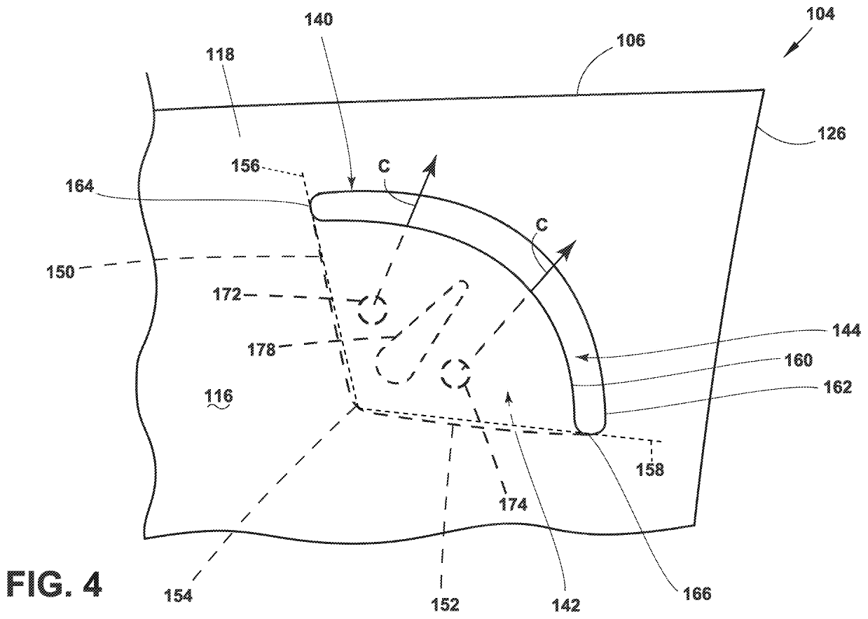

FIG. 4 is a schematic view of the cooling aperture 140 of FIG. 2 positioned along the outer wall 118 near the tip 106 and the trailing edge 126. At least a portion of the cooling aperture 140 defining the cavity 142 (represented in broken line) is arranged beneath the exterior surface 116, while the diffuser outlet 144 is provided along the exterior surface 116.

The cavity 142 is at least partially defined by a first side 150 and a second side 152. The first and second side 150, 152 meet at a junction 154, and terminate at the diffuser outlet 144 opposite of the junction 154. The junction 154 is positioned where the first side 150 meets the second side 152 opposite of the diffuser outlet 144. In an example, it is contemplated that a non-zero length, such as a curve, extends between the first side 150 and the second side 152 at the junction 154, where the junction 154 is positioned equidistant between the first side 150 and the second side 152.

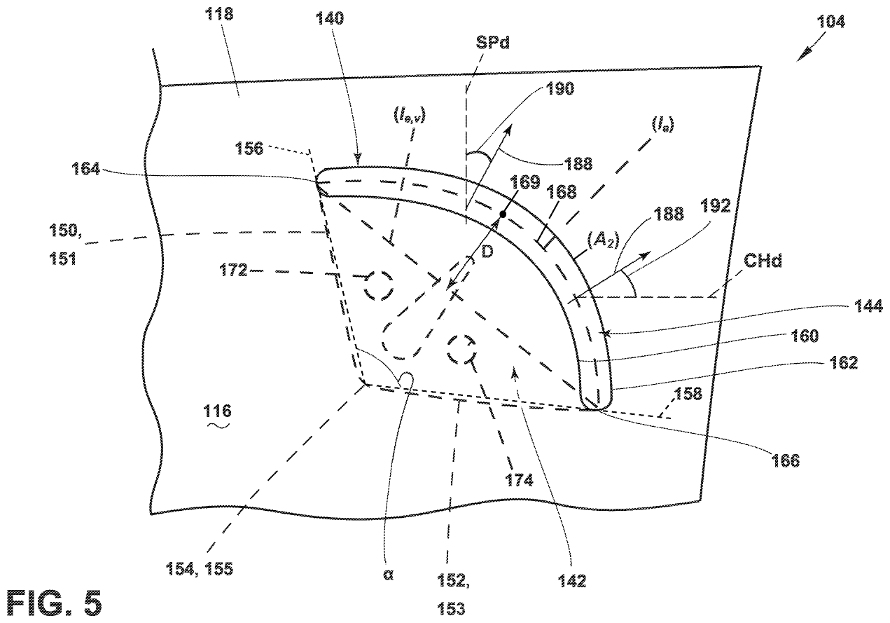

The diffuser outlet 144 is the opening in the exterior surface 116 where the cooling fluid flow (C) from the cavity 142 is exhausted or vented. The diffuser outlet 144 includes a forward edge 160 and an aft edge 162, with the forward edge 160 nearer to the junction 154 than the aft edge 162. In some examples, the forward edge 160 is positioned upstream of the aft edge 162 relative to a flow direction along the exterior surface 116. The forward edge 160 meets the aft edge 162 at a first end 164 at the first side 150 and at a second end 166 at the second side 152. The first end 164 is a first point on the diffuser outlet 144 where a first axis 156 extending from the junction 154 touches (meets) the outer most end of the diffuser outlet 144, and the second end 166 is a second point on the opposite end of the diffuser outlet 144 where a second axis 158 extending from the junction 154 touches (meets) the other outer most end of the diffuser outlet 144. The first and second axes 156, 158 are also shown in FIGS. 5, 6, and 7.

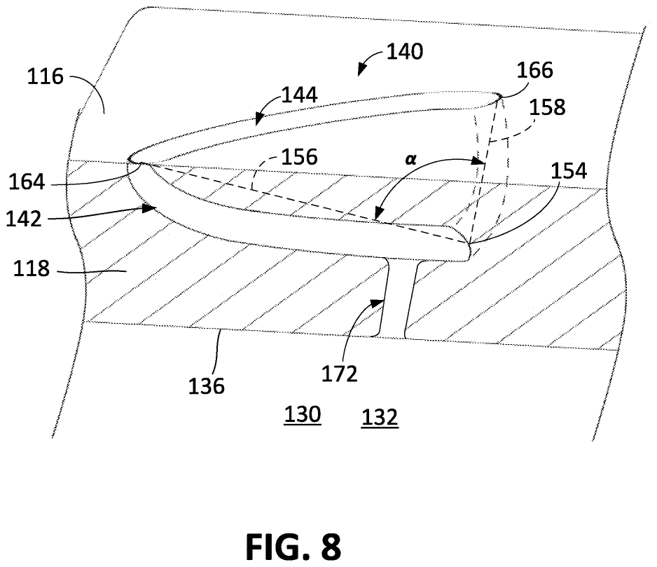

The cooling aperture 140 includes at least one metering hole that extends through a portion of the outer wall 118 and fluidly couples the cooling circuit 132 (FIG. 2) to the cavity 142. In the illustrated example, the cooling aperture 140 includes a first metering hole 172 and a second metering hole 174, shown in broken line, that fluidly couple the cavity 142 to the cooling circuit 132 (FIG. 2) to permit a volume of cooling fluid flow (C) to flow into the cavity 142 and ultimately exhaust at the diffuser outlet 144. For example, referring briefly to FIG. 8, a cross-sectional view of a portion of the outer wall 118 with the cooling aperture 140 is shown. The outer wall 118 has the exterior surface 116 and an interior surface 136 opposite the exterior surface 116. The interior surface 136 faces the interior 130 and forms or defines a portion of the cooling circuit 132. The cavity 142 is defined in the outer wall 118. As shown, the first metering hole 172 extends between the interior surface 136 and the cavity 142 (e.g., a location in the cavity 142 near the junction 154). The second metering hole 174 (not shown in FIG. 8) similarly extends between the interior surface 136 and the cavity 142. As such, the first and second metering holes 172, 174 fluidly couple the cooling circuit 132 and the cavity 142. The metering holes 172, 174 provide cooling fluid into the cavity 142, which is exhausted through the diffuser outlet 144 at the exterior surface 116. Referring back to FIG. 4, a pin 178, shown in broken line, is positioned within the cavity 142. The pin 178 has a teardrop, cross-sectional shape. The teardrop, cross-sectional shape tapers or narrows in a direction from the junction 154 toward the diffuser outlet 144. Further, the metering holes 172, 174 are on opposite sides of the pin 178. It should be appreciated that additional cross-sectional shapes for the pin 178 are contemplated, including but not limited to, circular, airfoil, racetrack, oval, elliptical, rounded, curved, linear, curvilinear, or combinations thereof.

FIG. 5 is the same schematic view of the cooling aperture 140 of FIG. 4 with additional axes and elements labeled. The diffuser outlet 144 defines a diffuser outlet area (A₂), which is the area of the diffuser outlet 144 at the exterior surface 116. The diffuser outlet area (A₂) is defined at the intersection where the diffuser outlet 144 meets the exterior surface 116. As such, the diffuser outlet area (A₂) corresponds to the area of the opening formed in the exterior surface 116 that defines the diffuser outlet 144.

The diffuser outlet 144 defines a diffuser outlet length (lₑ). The diffuser outlet length (lₑ) is measured along a curved line 168 (shown in dashed line) that is equidistant between the forward edge 160 and the aft edge 162, and extends between the first end 164 and the second end 166. Additionally, the diffuser outlet 144 defines a diffuser outlet vector length (l_{e,v}), which is defined as the vector length between the first end 164 and the second end 166 of the diffuser outlet 144. In other words, the diffuser outlet vector length (l_{e,v}) is the straight line distance between the first end 164 and the second end 166 of the diffuser outlet 144.

As shown in FIG. 5, the curved line 168 has a center point 169 that is halfway along the curved line 168 between the first and second ends 164, 166. A projected first side 151 corresponds to the first side 150 as projected onto a two-dimensional (2D) plane of the exterior surface 116, a projected second side 153 corresponds to the second side 152 as projected onto the 2D plane of the exterior surface 116, and a projected junction 155 corresponds to the junction 154 as projected onto the 2D plane of the exterior surface 116. Thus, the projected first side 151, the projected second side 153, the projected junction 155, and the diffuser outlet 144 are all on the same 2D plane of the exterior surface 116. The projected junction 155 is the furthest point on the projected first and second sides 151, 153 from the center point 169. Therefore, the projected junction 155 can be used to define the location of the junction 154 where the first and second sides 150, 152 meet.

A first axis 156 is defined extending from the junction 154 to the first end 164 and a second axis 158 is defined extending from the junction 154 to the second end 164. A side angle (α) is defined as the angle between the first axis 156 and the second axis 158. The side angle (α) represents the angle at which the cavity 142 widens or spreads out from the junction 154 to the diffuser outlet 144 as viewed in 2D. The junction 154, the first axis 156, the second axis 158, the first end 164, the second end 166, and the side angle (α) are also labeled in FIG. 8.

A radius of curvature of the curved line 168 (i.e., the radius of curvature of the diffuser outlet 144) can be calculated using the diffuser outlet vector length (l_{e,v}), which is the distance between the two ends 164, 166 of the diffuser outlet 144, and a maximum deflection (D) of the curved line 168 relative to the line representing the diffuser outlet vector length (l_{e,v}). The maximum deflection (D) occurs at the center point 169. The radius of curvature can be calculated using: Radius of Curvature=(D/2)+ (l_{e,v}²/(8×D)). A sector angle can be calculated using the ratio lₑ/Radius of Curvature.

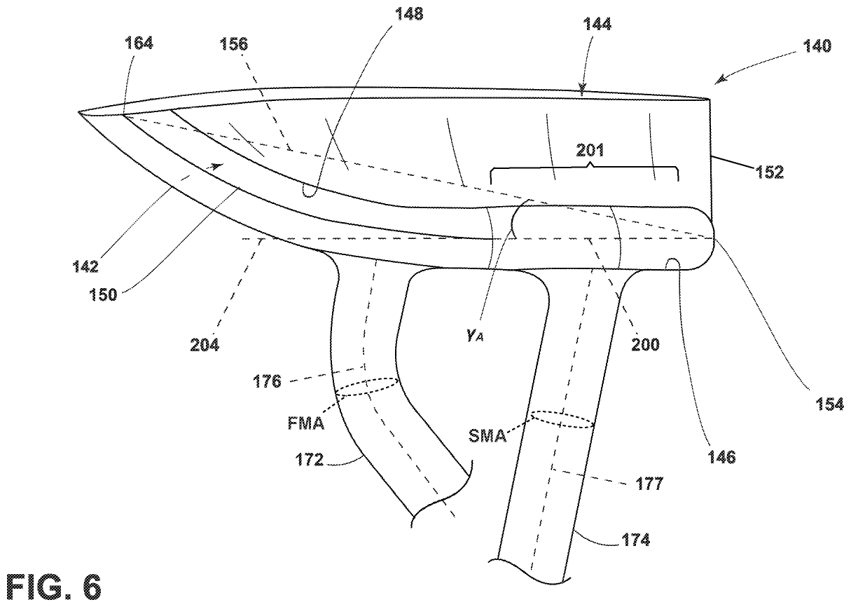

The cooling fluid flow (C) exhausts from the diffuser outlet 144 to define a set of flow components illustrated as flow components 188, which spreads along the exterior surface 116, exhausting from the diffuser outlet 144 as a cooling film along the exterior surface 116. Diffusion of the cooling fluid flow (C), flow components 188 thereof, or local directionalities thereof, are defined by arrangement or geometry of the first and second metering holes 172, 174, the pin 178 (FIG. 4), the diffuser outlet 144, and features defining the cavity 142 such as an inner surface 146 (FIG. 6), an outer surface 148 (FIG. 6), the outer wall 118, the first side 150, and the second side 152. Additionally, the flow rate for the cooling fluid flow (C) exhausting from the diffuser outlet 144 is a function of flow rate or pressure of the cooling fluid flow (C) within the cavity 142. Each of the flow components 188 may have an angular orientation, being arranged at a span-wise flow component angle 190 defined relative to the span-wise direction SPd, or a chord-wise flow component angle 192 defined relative to the chord-wise direction CHd. In a non-limiting example, the span-wise flow component angle 190 for the flow components 188 for the cooling fluid flow (C) exhausting the diffuser outlet 144 differs by greater than or equal to thirty degrees (30°), relative to a common direction, such as either of the span-wise direction SPd or the chord-wise direction CHd.

FIG. 6 shows a perspective view of an exterior perimeter of the cooling aperture 140, showing the first side 150 extending from the junction 154. The cavity 142 has an inner surface 146 and an outer surface 148 in the outer wall 118 (FIG. 2) that at least partially define the cavity 142. The inner surface 146 is the surface of the cavity 142 closest to the cooling circuit 132 (FIG. 2) and may be considered the cold surface, while the outer surface 148 is the surface of the cavity 142 closest to the exterior surface 116 (FIG. 2) and may be considered the hot surface. The outer surface 148 meets the inner surface 146 at the first side 150 and the second side 152. The junction 154 is the point where the first side 150 and the second side 152 meet and is midway between the outer surface 148 and the inner surface 146. The first and second metering holes 172, 174 are appreciable, feeding the cavity 142 from the cooling circuit 132 (FIG. 2) through the inner surface 146. The pin 178 (FIG. 4) is disposed in the cavity 142 and extends between the inner surface 146 and the outer surface 148.

The first and second metering holes 172, 174 each have a minimum cross-sectional area (labeled as FMA, SMA) defined as the smallest cross-sectional area for each of the first and second metering holes 172, 174 perpendicular to a longitudinal axis 176, 177 extending along the length of each of the first and second metering holes 172, 174. The minimum cross-sectional area (FMA) for the first metering hole 172 is defined perpendicular to the longitudinal axis 176 defined extending through the first metering hole 172. Similarly, the minimum cross-sectional area (SMA) for the second metering hole 174 is defined perpendicular to the longitudinal axis 177 defined extending through the second metering hole 174. The minimum cross-sectionals areas (FMA, SMA) may occur anywhere between the inlet and the outlets of the metering holes 172, 174. Where more than one metering hole is utilized, a metering hole area (A₁) of the cooling aperture 140 is the sum of the minimum cross-sectional for each of the first metering holes. For example, the metering hole area (A₁) of the cooling aperture 140 is the sum of the minimum cross-sectional areas FMA and SMA. Where only a single metering hole is utilized, the metering hole area (A₁) for the cooling aperture 140 is defined as the minimum cross-sectional area for the single metering hole (e.g., only FMA).

As shown in FIG. 6, the cavity 142 has a linear portion 201 where the inner surface 146 and the outer surface 148 are planar and parallel to each other. A virtual plane 200 is defined within the cavity 142, extending through the junction 154, and spaced equidistant between the inner surface 146 and the outer surface 148 along the linear portion 201. The geometry of the cooling aperture 140 is such that at least a portion of the cavity 142 is defined between parallel and planar portions of the inner surface 146 and the outer surface 148. That is, at least a portion of the cavity 142 is defined between planar portions of the inner surface 146 and the outer surface 148, which are arranged parallel to one another. The virtual plane 200 is defined as a plane equidistant from the parallel and planar portions of the inner surface 146 and the outer surface 148, extending through the junction 154. In some examples, the cavity 142 is oriented such that the virtual plane 200 is parallel to the exterior surface 116 (FIGS. 4 and 5). As such, at least a portion of the inner and outer surfaces 146, 148 may be parallel to the exterior surface 166. However, in other examples, the inner and outer surfaces 146, 148 along the linear portion 201 may not be parallel to the exterior surface 116.

The first axis 156 is defined extending between the junction 154 and the first end 164 of the diffuser outlet 144. A first side axis 204 is defined as a projection of the first axis 156 onto the virtual plane 200. A first curvature angle (γ_{A}) is defined as the angle between the first axis 156 and the first side axis 204.

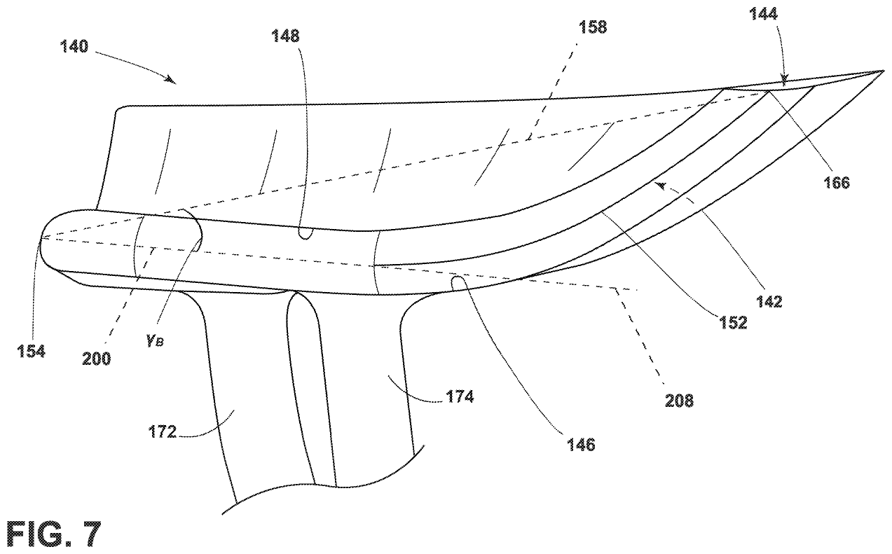

FIG. 7, similar to that of FIG. 6, shows another side view of the exterior perimeter of the cooling aperture 140, showing the second side 152. The outer surface 148 meets the inner surface 146 at the second side 152.

The virtual plane 200 is defined within the cavity 142, similar to that shown in FIG. 6. The second axis 158 is defined extending between the junction 154 and the second end 166 of the diffuser outlet 144. A second side axis 208 is defined as a projection of the second axis 158 onto the virtual plane 200. A second curvature angle (γ_{B}) is defined as the angle between the second axis 158 and the second side axis 208.

In operation, a volume of the cooling fluid flow (C) (FIG. 4) is provided to the cavity 142 from the first and second metering holes 172, 174 where the cooling fluid flow (C) can impinge upon the outer surface 148. The cooling fluid flow (C) spreads within the cavity 142, where it cools adjacent areas of the outer wall 118, including the inner surface 146, the outer surface 148, the first side 150, and the second side 152. The particular directionalities for the spread of the cooling fluid flow (C) are dependent on the location, number, and geometry for the first and second metering holes 172, 174 and the pin 178 (FIG. 4), as well as the particular arrangement and geometry for the cavity 142 as defined by the inner surface 146, outer surface 148, the outer wall 118, the first side 150, the second side 152, and the diffuser outlet 144. The cooling fluid flow (C) (FIG. 4) exhausts from the diffuser outlet 144, which spreads along the hot exterior surface 116 of the outer wall 118, downstream of the diffuser outlet 144, as a cooling film along the outer wall 118. Diffusion of the cooling fluid flow (C) (FIG. 4), flow components 188 thereof, or local directionalities thereof, are defined by arrangement or geometry of the first and second metering holes 172, 174, the outer wall 118, including the inner surface 146, the outer surface 148, the first side 150, and the second side 152, the pin 178 (FIG. 4), and the diffuser outlet 144, as well as a function of flow rate or pressure of the cooling fluid flow (C) (FIG. 4).

The cooling aperture 140 provides a shape that yields higher local cooling performance with greater heat transfer, as well as greater effective film coverage area as compared to traditional drilled or cast cooling methods and holes. The particular shape leverages additive manufacturing techniques to permit unconventional shapes previously not possible with traditional manufacture methods like drilling and casting. Additionally, the shape of the cooling aperture 140 increases manufacturability, as the cooling aperture's shape increases ligament area in the print plane, which is typically parallel to or almost parallel to the platform 110 (FIG. 2).

The turbine blade assemblies 100 of the HP turbine 34 and, specifically, the stage one blade assemblies 100 of the HP turbine 34 have the highest flow path temperature of any blade set. These stage one turbine blade assemblies 100 also rotate at extremely high angular velocities. The extreme temperature environment and the high rotational speeds impart large forces on the turbine blade assemblies 100 that can lead to creep and fatigue. Creep and fatigue may result in an unexpected or premature part replacement that limits engine Time on Wing (TOW). Finding a workable solution to facilitating heat transfer for the airfoil, such as along areas near the tip and trailing edge, as well as bridging cooling film gaps among nearby film holes, involves finding the balance between the geometry of the cooling hole to provide local cooling, the width of the outlet to provide a particular width of cooling film, and the flow rates of the cooling aperture defined by the flow of cooling fluid anticipated to be supplied to the cooling aperture, as well as the geometry of the cooling aperture itself. This is a labor and time-intensive process due to the process being iterative and involving the selection of various dimensions, there are numerous variations which are within the performance requirements for the cooling aperture described herein. Put another way, the airfoil and cooling aperture, and geometries thereof, were determined accordingly for various configurations before a range of particular geometries was created that satisfies all design requirements, e.g., aerodynamic performance, flow rates, durability, local cooling performance, cooling film generation and performance, engine efficiency, sizing constraints within current engine systems, or the like.

The inventors developed multiple blade assembly designs and determined that the metering hole area (A₁), the diffuser outlet area (A₂), the diffuser outlet length (lₑ), the diffuser outlet vector length (l_{e,v}), and the side angle (α) have a significant effect on the durability of the blade assembly 100. In particular, these parameters contribute to the cooling performance of the cooling aperture 140, as well as the airfoil 104 or other component including the cooling aperture 140. These parameters and their unique relationships, disclosed in further detail below, have an effect on the heat transfer, film effectiveness, and pressure drop amounts.

The metering hole area (A₁) affects the volume and flow rate of cooling fluid flow provided to the cooling aperture 140, which determines the availability of flow volume for heat transfer and cooling film production. The diffuser outlet area (A₂) affects the volume and flow rate of cooling fluid flow exhausted from the cooling aperture 140 as a cooling film, and must be balanced with the cooling fluid flow provided by the metering hole area (A₁) in order to ensure there is enough available cooling fluid flow to achieve an effective cooling film for the cooling fluid flow exhausting from the diffuser outlet 144. The diffuser outlet length (lₑ) affects the size and length of the diffuser outlet 144, while the diffuser outlet vector length (l_{e,v}) affects curvature of the diffuser outlet 144. A balance among the diffuser outlet length (lₑ) and the diffuser outlet vector length (l_{e,v}) ensures that the size, shape, and curvature for the diffuser outlet 144 are maximized to provide an effective cooling film over an area of the airfoil 104. Furthermore, as the metering hole area (A₁) increases, manufacturability of the cooling aperture 140 increases, resulting in an increase in yield. To this end, the sizing of the metering hole area (A₁) is maximized, but must be balanced with anticipated flow rates and volumes to ensure that a suitable amount of cooling fluid is provided to achieve suitable heat transfer, as well as developing an effective cooling film after exhausting from the diffuser outlet 144. Therefore, the sizing of the metering hole is used to balance manufacturability with specific heat transfer and cooling film requirements.

The side angle (α), determined by the first axis 156 and the second axis 158, defines the rate at which the cooling aperture 140 expands toward the diffuser outlet 144. The side angle (α) affects heat transfer by maximizing width of the cooling aperture 140, thereby maximizing surface area for heat transfer, while ensuring that the cooling aperture 140 is within suitable width and sizing ranges to permit effective cooling film to exhaust from the diffuser outlet 144.

Therefore, the inventors determined during the course of their turbine blade assembly design that the metering hole area (A₁), the diffuser outlet area (A₂), the diffuser outlet length (lₑ), the diffuser outlet vector length (l_{e,v}), and the side angle (α) have an effect on the durability of the turbine blade assembly 100. Based on these parameters, the inventors created solutions with relatively high blade durability for a defined engine environment. Table 1 below illustrates ten examples (denoted Ex. 1-10) of turbine blade assemblies 100 with cooling apertures 140 developed by the inventors. Table 1 includes values for the metering hole area (A₁), the diffuser outlet area (A₂), the diffuser outlet length (lₑ), the diffuser outlet vector length (l_{e,v}), and the side angle (α) for each of the Examples 1-10.

TABLE 1

| | A₁ | A₂ | lₑ | l_{e, v} | α |
|---|---|---|---|---|---|
| Units | mm² | mm² | mm | mm | radians |
| Ex. 1 | 0.051 | 0.129 | 1.524 | 1.295 | 0.524 |
| Ex. 2 | 0.456 | 4.000 | 7.167 | 6.096 | 2.356 |
| Ex. 3 | 0.456 | 0.129 | 1.524 | 1.295 | 2.356 |
| Ex. 4 | 0.051 | 4.000 | 7.167 | 6.096 | 0.524 |
| Ex. 5 | 0.099 | 2.052 | 6.756 | 5.743 | 2.129 |
| Ex. 6 | 0.343 | 0.994 | 5.690 | 4.836 | 1.484 |
| Ex. 7 | 0.114 | 2.194 | 6.426 | 5.462 | 1.710 |
| Ex. 8 | 0.061 | 3.426 | 4.567 | 3.865 | 2.339 |
| Ex. 9 | 0.051 | 1.568 | 2.819 | 2.397 | 2.217 |
| Ex. 10 | 0.203 | 0.910 | 4.267 | 3.627 | 1.710 |

The designs of Table 1 are beneficial for increased heat transfer and effective application of film cooling, while operating within flow rate and pressure requirements. The geometry of each cooling aperture 140 when within a specific range improves cooling of the airfoil, improves local heat transfer, and improves effectiveness and size of a cooling film exhausting from the cooling aperture 140. The cooling architecture described herein is based on a relationship among a combination of the metering hole area (A₁), the diffuser outlet area (A₂), the diffuser outlet length (lₑ), and the diffuser outlet vector length (l_{e,v}). The cooling architecture can also based on a relationship among a combination of the metering hole area (A₁), the diffuser outlet area (A₂), the diffuser outlet length (lₑ), the diffuser outlet vector length (l_{e,v}), and the side angle (α).

It was found, based upon the Examples provided in Table 1, that the geometries of the cooling aperture 140 result in a highly useful and desirable airfoil, with effective heat transfer, cooling film effectiveness and coverage area resulting in increased durability and cycle life, as well as maintaining appropriate sizing and tolerances for use in existing engine systems.

The designs developed by the inventors shown in Table 1 can be characterized by an Expression 1 (EQ1) that can be used to distinguish those designs in Examples 1-10 that meet the performance (durability) requirements from those designs that do not meet the performance requirements. As such, the Expression EQ1 can be used to identify an improved blade assembly design, better suited for a particular engine operating environment and taking into account the constraints imposed on such blade assembly designs.

Expression 1 (EQ1) is defined as:

$$( \frac{{A}_{2}}{{A}_{1}} ) ( \frac{{l}_{e}}{{l}_{e , v}} ) \qquad EQ 1$$

In Expression 1 (EQ1), A₂ represents the area of the diffuser outlet 144, A₁ represents the metering hole area of the cooling aperture 140, (lₑ) represents the length of the diffuser outlet 144, and (l_{e,v}) represents the vector length of the diffuser outlet 144.

Further, the designs developed by the inventors shown in Table 1 can be characterized by an Expression 2 (EQ2) that takes into account the side angle (α).is defined as:

$$( \frac{{A}_{2}}{{A}_{1}} ) ( \frac{{l}_{e}}{{l}_{e , v}} ) ( \frac{1}{α} ) \qquad EQ2$$

In Expression 2 (EQ2), A₂ represents the area of the diffuser outlet 144, A₁ represents the metering hole area of the cooling aperture 140, (lₑ) represents the length of the diffuser outlet 144, (l_{e,v}) represents the vector length of the diffuser outlet 144, and (α) represents the angle between the first axis 156 and the second axis 158.

Values for EQ1 and EQ2 for each of the Examples 1-10 of Table 1 are shown in Table 2 below.

TABLE 2

| | A₁ | A₂ | lₑ | l_{e, v} | α | EQ1 | EQ2 |
|---|---|---|---|---|---|---|---|
| Units | mm² | mm² | mm | mm | radians | Unitless | 1/radians |
| Ex. 1 | 0.051 | 0.129 | 1.524 | 1.295 | 0.524 | 2.98 | 5.68 |
| Ex. 2 | 0.456 | 4.000 | 7.167 | 6.096 | 2.356 | 10.31 | 4.38 |
| Ex. 3 | 0.456 | 0.129 | 1.524 | 1.295 | 2.356 | 0.33 | 0.14 |
| Ex. 4 | 0.051 | 4.000 | 7.167 | 6.096 | 0.524 | 92.21 | 175.98 |
| Ex. 5 | 0.099 | 2.052 | 6.756 | 5.743 | 2.129 | 24.38 | 11.45 |
| Ex. 6 | 0.343 | 0.994 | 5.690 | 4.836 | 1.484 | 3.41 | 2.30 |
| Ex. 7 | 0.114 | 2.194 | 6.426 | 5.462 | 1.710 | 22.64 | 13.24 |
| Ex. 8 | 0.061 | 3.426 | 4.567 | 3.865 | 2.339 | 66.36 | 28.37 |
| Ex. 9 | 0.051 | 1.568 | 2.819 | 2.397 | 2.217 | 36.16 | 16.31 |
| Ex. 10 | 0.203 | 0.910 | 4.267 | 3.627 | 1.710 | 5.27 | 3.08 |

It was found that a range of values for EQ1 and EQ2 correlate to a high performing cooling aperture 140 with peak performance utilizing the factors discussed herein, while values outside of such ranges correlate to a lower performing cooling aperture. While narrowing these multiple factors to a region of possibilities saves time, money, and resources, the largest benefit is at the system level, where improved airfoils enable improved system performance.

In particular, based on the EQ1 values of Examples 1-10 in Table 2, it was determined that turbine blade assembly designs with an EQ1 value in the range of 0.33 to 92.21 (i.e., 0.33≤EQ1≤92.21) advantageously meet the durability requirements while remaining within desired tolerances and being capable of use in existing engine systems. Further, based on the EQ2 values of Examples 1-10 in Table 2, it was determined that blade assembly designs with an EQ2 value in the range of 0.14 to 175.98 (i.e., 0.14≤EQ2≤175.98) advantageously meet the durability requirements while remaining within desired tolerances and being capable of use in existing engine systems. As such, benefits are realized when a turbine blade assembly 100 has a geometry where EQ1 falls within the range of 0.33 to 92.21 (i.e., 0.33≤EQ1≤92.21) and/or EQ2 falls within the range of 0.14 to 175.98 (i.e., 0.14≤EQ2≤175.98). Therefore, a turbine blade assembly design having parameters that meet either or both of EQ1 or EQ2 provide the enumerated benefits.

Table 3 below illustrates minimum and maximum values for the metering hole area (A₁), the diffuser outlet area (A₂), the diffuser outlet length (lₑ), the diffuser outlet vector length (l_{e,v}), and the side angle (α), along with a range of values for EQ1 and EQ2 suited for a turbine blade assembly that meets the durability requirements.

TABLE 3

| Parameter: | Element: | Units: | Minimum | Maximum |
|---|---|---|---|---|
| (A₁) | Metering Hole Area | mm² | 0.051 | 0.456 |
| (A₂) | Diffuser Outlet Area | mm² | 0.129 | 4.000 |
| (lₑ) | Diffuser Outlet Length | mm | 1.524 | 7.167 |
| (l_{e, v}) | Diffuser Outlet Vector | mm | 1.295 | 6.096 |
| | Length | | | |
| (α) | Angle Between | radians | 0.524 | 2.356 |
| | Side Axes | | | |
| EQ1 | Expression 1 | Unitless | 0.33 | 92.21 |
| EQ2 | Expression 2 | 1/radians | 0.14 | 175.98 |

The values defining the cooling aperture 140 within the ranges of Table 3 provide for more effective heat transfer, greater cooling film effectiveness and larger coverage area, as compared to designs outside of such ranges. Therefore, such a cooling aperture 140 within the ranges of Table 3 provides for increased component durability, lifetime, and reduced maintenance as compared with designs outside of the ranges.

Benefits include an improvement in local heat transfer and cooling of the airfoil 104, as well as providing an effective cooling film over a relatively larger area of the airfoil 104 as compared to that of traditional film holes or cooling holes outside of the geometries defined by Expression 1 and Expression 2. Such improvements increase overall component and engine efficiency, requiring a lesser total cooling flow volume to cool a region of the airfoil 104 including the cooling aperture 140. This provides for increased durability for the airfoil 104, which decreases required maintenance and costs, while increasing overall engine reliability.

Further still, the benefits included herein provide for an airfoil 104 with the cooling aperture 140 that fits within existing engines. For example, the values for EQ1 and EQ2 as provided herein take existing engines into consideration, permitting replacement of current blade assemblies with replacement blade assemblies (or new blade assemblies) having the parameters of the cooling aperture 140 described herein. Such consideration provides for replacing and improving current engine systems. This provides for improving current engine durability without increasing costs to prepare new engines or further adapt existing engines.

The aforementioned relationships determined by the inventors are expressed in terms of EQ1 and EQ2. The ranges associated with EQ1 and EQ2 identified an improved airfoil 104 design with an improved cooling aperture 140 design, better suited for a particular engine operating environment and taking into account the constraints imposed on a blade assembly design with the cooling aperture 140 used in such a system.

The inventors also developed multiple blade assembly designs and determined the diffuser outlet length (lₑ), the diffuser outlet vector length (l_{e,v}), the first curvature angle (γ_{A}), and the second curvature angle (γ_{B}) for the cooling aperture 140 contribute to the cooling performance of the cooling aperture 140, as well as the airfoil 104 or other component including the cooling aperture 140. These parameters and their unique relationship, disclosed in further detail below, have an effect on the heat transfer, film effectiveness, and pressure drop amounts.

Regarding the relationship among the first curvature angle (γ_{A}) and the second curvature angle (γ_{B}), the relationship defines the curvature of the cooling aperture 140 extending from the junction 154 to the diffuser outlet 144. A relatively greater curvature provides relatively increased heat transfer, with greater surface area in contact with the cooling fluid flow than that with lesser or no curvature. The curvatures defined by the first curvature angle (γ_{A}) and the second curvature angle (γ_{B}) must be balanced with one another to ensure that the first side 150 and the second side 152 do not differ too greatly, which negatively impacts heat transfer performance, but are near enough to prevent flow separation not only within the cooling aperture 140, but also to prevent flow separation, thin spots, or limited flow availability to ensure that an effective cooling film is provided from the diffuser outlet 144.

The relationship among the first curvature angle (γ_{A}), the second curvature angle (γ_{B}), the diffuser outlet length (lₑ), and the diffuser outlet vector length (l_{e,v}) is similar to the relationship among the first curvature angle (γ_{A}) and the second curvature angle (γ_{B}) as discussed above, while including consideration of the diffuser outlet length (lₑ), and the diffuser outlet vector length (l_{e,v}). The diffuser outlet length (lₑ) affects the size and length of the diffuser outlet 144, while the diffuser outlet vector length (l_{e,v}) affects curvature of the diffuser outlet 144. A balance among the diffuser outlet length (lₑ) and the diffuser outlet vector length (l_{e,v}) ensures that the size, shape, and curvature for the diffuser outlet 144 are maximized to lay down an effective cooling film over an area of the airfoil 104. These aspects are balanced with the first curvature angle (γ_{A}) and the second curvature angle (γ_{B}) to ensure that the size and shape of the diffuser outlet 144 are suitable to provide an effective cooling film while considering the first curvature angle (γ_{A}) and the second curvature angle (γ_{B}). A balance must be achieved between the first curvature angle (γ_{A}) and the second curvature angle (γ_{B}), and the diffuser outlet length (lₑ), and the diffuser outlet vector length (l_{e,v}) to ensure that the diffuser outlet 144 is sized and shaped appropriately to permit an effective cooling film to be provided within the constraints maximizing heat transfer of the cooling aperture 140 defined by the first curvature angle (γ_{A}) and the second curvature angle (γ_{B}). Additionally, a balance must be achieved between the diffuser outlet length (lₑ) and the diffuser outlet vector length (l_{e,v}) to maximize manufacturability. Portions of the cooling aperture 140 manufactured with long ligaments having no curvature negatively impacts yield. Therefore, a balance must be achieved between the diffuser outlet length (lₑ) and the diffuser outlet vector length (l_{e,v}) to minimize long ligaments with no curvature to improve manufacturability and yield, while maximizing diffuser length and curve to maximize cooling film coverage, while remaining within suitable flow rates and volumes.

Table 4 below illustrates ten examples (denoted Ex. 11-20) of turbine blade assemblies 100 developed by the inventors. Table 4 includes values for the first curvature angle (γ_{A}), the second curvature angle (γ_{B}), the diffuser outlet length (lₑ), and the diffuser outlet vector length (l_{e,v}) for each of the Examples 11-20.

TABLE 4

| | γ_{A} | γ_{B} | lₑ | l_{e, v} |
|---|---|---|---|---|
| Units | radians | radians | mm | mm |
| Ex. 11 | 0.227 | 0.227 | 1.524 | 1.295 |
| Ex. 12 | 0.524 | 0.524 | 7.167 | 6.096 |
| Ex. 13 | 0.227 | 0.524 | 1.524 | 6.096 |
| Ex. 14 | 0.524 | 0.227 | 7.167 | 1.295 |
| Ex. 15 | 0.384 | 0.454 | 2.54 | 5.055 |
| Ex. 16 | 0.332 | 0.367 | 7.137 | 4.724 |
| Ex. 17 | 0.262 | 0.297 | 1.956 | 1.651 |
| Ex. 18 | 0.297 | 0.384 | 1.829 | 5.359 |
| Ex. 19 | 0.384 | 0.401 | 3.073 | 4.039 |
| Ex. 20 | 0.367 | 0.227 | 4.242 | 5.182 |

The designs of Table 4 are beneficial for increased heat transfer and effective application of film cooling, while operating within flow rate and pressure requirements. The geometry of each cooling aperture 140 when within a specific range improves cooling of the airfoil, improves local heat transfer, and improves effectiveness and size of a cooling film exhausting from the cooling aperture 140. The cooling architecture described herein is based on a relationship among the first curvature angle (γ_{A}) and the second curvature angle (γ_{B}) and a relationship among the first curvature angle (γ_{A}), the second curvature angle (γ_{B}), the diffuser outlet length (lₑ), and the diffuser outlet vector length (l_{e,v}).

It was found, based upon the Examples provided in Table 4, that the geometries of the cooling aperture 140 result in a highly useful and desirable airfoil, with effective heat transfer, cooling film effectiveness and coverage area resulting in increased durability and cycle life, as well as maintaining appropriate sizing and tolerances for use in existing engine systems.

The designs developed by the inventors shown in Table 4 can be characterized by an Expression 3 (EQ3) that can be used to distinguish those designs in Examples 11-20 that meet the performance (durability) requirements from those designs that do not meet the performance requirements. As such, the Expression EQ3 can be used to identify an improved blade assembly design, better suited for a particular engine operating environment and taking into account the constraints imposed on such turbine blade assembly designs.

Expression 3 (EQ3) is defined as:

$$( \frac{{γ}_{A}}{{γ}_{B}} ) \qquad EQ3$$

In Expression 3 (EQ3), YA represents the first curvature angle (γ_{A}), and YB represents the second curvature angle (B).

Further, the designs developed by the inventors shown in Table 4 can be characterized by an Expression 4 (EQ4) that takes into account diffuser outlet length (lₑ) and the diffuser outlet vector length (l_{e,v}). Expression 4 (EQ4) is defined as:

$$( \frac{{γ}_{A}}{{γ}_{B}} ) ( \frac{{l}_{e}}{{l}_{e , v}} ) \qquad EQ4$$

In Expression 4 (EQ4), YA represents the first curvature angle (γ_{A}), YB represents the second curvature angle (γ_{B}), (lₑ) represents length of the diffuser outlet 144, and (l_{e,v}) represents the vector length between ends of the diffuser outlet 144.

Values for EQ3 and EQ4 for each of the Examples 11-20 of Table 4 are shown in Table 5.

TABLE 5

| | γ_{A} | γ_{B} | lₑ | l_{e, v} | EQ3 | EQ4 |
|---|---|---|---|---|---|---|
| Units | radians | radians | mm | mm | Unitless | Unitless |
| Ex. 11 | 0.227 | 0.227 | 1.524 | 1.295 | 1.00 | 1.18 |
| Ex. 12 | 0.524 | 0.524 | 7.167 | 6.096 | 1.00 | 1.18 |
| Ex. 13 | 0.227 | 0.524 | 1.524 | 6.096 | 0.43 | 0.11 |
| Ex. 14 | 0.524 | 0.227 | 7.167 | 1.295 | 2.31 | 12.78 |
| Ex. 15 | 0.384 | 0.454 | 2.54 | 5.055 | 0.85 | 0.42 |
| Ex. 16 | 0.332 | 0.367 | 7.137 | 4.724 | 0.90 | 1.37 |
| Ex. 17 | 0.262 | 0.297 | 1.956 | 1.651 | 0.88 | 1.05 |
| Ex. 18 | 0.297 | 0.384 | 1.829 | 5.359 | 0.77 | 0.26 |
| Ex. 19 | 0.384 | 0.401 | 3.073 | 4.039 | 0.96 | 0.73 |
| Ex. 20 | 0.367 | 0.227 | 4.242 | 5.182 | 1.62 | 1.32 |

It was found that a range of values for EQ3 and EQ4 correlate to a high performing cooling aperture 140 with peak performance utilizing the factors discussed herein, while values outside of such ranges correlate to a lower performing cooling aperture. While narrowing these multiple factors to a region of possibilities saves time, money, and resources, the largest benefit is at the system level, where improved airfoils enable improved system performance.

In particular, based on the EQ3 values of Examples 11-20 in Table 5, it was determined that turbine blade assembly designs with an EQ3 value in the range of 0.43 to 2.31 (i.e., 0.43≤EQ3≤2.31) advantageously meet the durability requirements while remaining within desired tolerances and being capable of use in existing engine systems. Further, based on the EQ4 values of Examples 11-20 in Table 5, it was determined that blade assembly designs with an EQ4 value in the range of 0.11 to 12.78 (i.e., 0.11≤EQ4≤12.78) advantageously meet the durability requirements while remaining within desired tolerances and being capable of use in existing engine systems. As such, benefits are realized when a manufactured component including the blade assembly 100 has a geometry where EQ3 falls within the range of 0.43 to 2.31 (i.e., 0.43≤EQ3≤2.31) and/or EQ4 falls within the range of 0.11 to 12.78 (i.e., 0.11≤EQ4≤12.78).

Table 6 below illustrates minimum and maximum values for the first curvature angle (γ_{A}) and the second curvature angle (γ_{B}), and the diffuser outlet length (lₑ), and the diffuser outlet vector length (l_{e,v}), along with a range of values for EQ3 and EQ4 suited for a blade assembly that meets the durability requirements.

TABLE 6

| Parameter: | Element: | Units: | Minimum | Maximum |
|---|---|---|---|---|
| (γ_{A}) | Angle of Curvature of First | Radians | 0.227 | 0.524 |
| | Side | | | |
| (γ_{B}) | Angle of Curvature of | Radians | 0.227 | 0.524 |
| | Second Side | | | |
| (lₑ) | Diffuser Outlet Length | mm | 1.524 | 7.167 |
| (l_{e, v}) | Diffuser Outlet Vector | mm | 1.295 | 6.096 |
| | Length | | | |
| EQ3 | Expression 3 | unitless | 0.43 | 2.31 |
| EQ4 | Expression 4 | unitless | 0.11 | 12.78 |

The values defining the cooling aperture 140 within the ranges of Table 6 provide for more effective heat transfer, greater cooling film effectiveness and larger coverage area, as compared to designs outside of such ranges. Therefore, such a cooling aperture 140 within the ranges of Table 6 provides for increased component durability, lifetime, and reduced maintenance as compared with designs outside of the ranges.

Benefits include an improvement in local heat transfer and cooling of the airfoil 104, as well as providing an effective cooling film over a relatively larger area of the airfoil 104 as compared to that of traditional film holes or cooling holes outside of the geometries defined by Expression 3 and Expression 4. Such improvements increase overall component and engine efficiency, requiring a lesser total cooling flow volume to cool a region of the airfoil 104 including the cooling aperture 140. This provides for increased durability for the airfoil 104, which decreases required maintenance and costs, while increasing overall engine reliability.

Further still, the benefits included herein provide for an airfoil 104 with the cooling aperture 140 that fits within existing engines. For example, the values for EQ3 and EQ4 as provided herein take existing engines into consideration, permitting replacement of current airfoils with replacement airfoils (or new airfoils) having the parameters of the cooling aperture 140 described herein. Such consideration provides for replacing and improving current engine systems. This provides for improving current engine durability without increasing costs to prepare new engines or further adapt existing engines.

The aforementioned relationships determined by the inventors are expressed in terms of EQ3 and EQ4. The ranges associated with EQ3 and EQ4 identified an improved airfoil 104 design with an improved cooling aperture 140 design, better suited for a particular engine operating environment and taking into account the constraints imposed on airfoil 104 design with the cooling aperture 140 used in such a system.

Benefits associated with the cooling aperture 140 described herein include a quick visualization of tradeoffs, in terms of heat transfer effectiveness and cooling film effectiveness that are bounded by the constraints imposed by a geometric envelope available. The geometric envelope determined by the engine component being manufactured, such as the airfoil 104, as well as the location in the engine of the engine component, the materials used, available flow rates, component sizes or available space to incorporate the design, or any other design constraint. Narrowing these multiple factors to a region of possibilities saves time, money, and resources, as well as producing a superior performing airfoil.

The example cooling apertures disclosed herein are described in connection with an airfoil of a turbine blade assembly. However, any of the example cooling apertures disclosed herein can be similarly implemented in connection with other parts of a turbine blade assembly, such as on an interior wall or rib, a tip wall, on a platform of a turbine blade assembly. For instance, the platform may have one or more internal cooling cavities that receive cooling fluid, and one or more cooling apertures can be provided on the upper or lower surface of the platform to exhaust the cooling fluid to the exterior surface of the platform. Further, any of the example cooling apertures can be implemented on other types of components of a gas turbine engine that require or utilize cooling architecture, such as a fan blade (e.g., fan blade 42 of FIG. 1), a compressor blade (e.g., compressor blade 56, 58 of FIG. 1), a stationary vane (e.g., vane 60, 62, 72, 74 of FIG. 1), a strut, a shroud, a service tube, or a combustion liner wall.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

A turbine blade assembly for a gas turbine engine, the turbine blade assembly comprising: an airfoil including an outer wall defining an interior, the outer wall having an interior surface facing the interior and an exterior surface opposite the interior surface; a cooling circuit in the interior to provide a flow of cooling fluid; and a cooling aperture in the outer wall and fluidly coupled to the cooling circuit, the cooling aperture comprising: a cavity; at least one metering hole that fluidly couples the cooling circuit and the cavity, with the at least one metering hole defining a longitudinal axis; a diffuser outlet exhausting from the cavity at the exterior surface, the diffuser outlet having a forward edge spaced from an aft edge, the forward edge meeting the aft edge at a first end and a second end; a metering hole area (A₁) of the cooling aperture is defined as the minimum cross-sectional area of the at least one metering hole when only one metering hole is present or a sum of the minimum cross-sectional areas of the at least one metering hole when multiple metering holes are present, wherein the metering hole area (A₁) is 0.051 to 0.456 millimeters squared (m²); a diffuser outlet area (A₂) defined as an area of the diffuser outlet at the exterior surface of the airfoil, wherein the diffuser outlet area (A₂) is 0.129 to 4.000 mm²; a diffuser outlet length (lₑ) defined as a length measured along a curved line that is equidistant between the forward edge and the aft edge and extends between the first end and the second end of the diffuser outlet, wherein the diffuser outlet length (lₑ) is 1.524 to 7.167 millimeters (mm); and a diffuser outlet vector length (l_{e,v}) defined as a vector length measured extending between the first end and the second end of the diffuser outlet, wherein the diffuser outlet vector length (l_{e,v}) is 1.295 to 6.096 mm; wherein

$$0.33 \leq ( \frac{{A}_{2}}{{A}_{1}} ) ( \frac{{l}_{e}}{{l}_{e , v}} ) \leq 92.21 .$$

The turbine blade assembly of any preceding clause, wherein the cavity is defined by a first side and a second side meeting at a junction, wherein a first axis extends from the junction to the first end of the diffuser outlet, wherein a second axis extends from the junction to the second end of the diffuser outlet, wherein a side angle (α) is defined as an angle between the first axis and the second axis, and wherein

$$0.14 \leq ( \frac{{A}_{2}}{{A}_{1}} ) ( \frac{{l}_{e}}{{l}_{e , v}} ) ( \frac{1}{α} ) \leq 175.98 .$$

The turbine blade assembly of any preceding clause, further comprising at least one pin in the cavity, wherein the cavity is further defined between an inner surface and an outer surface, and wherein the at least one pin extends between the inner surface and the outer surface.

The turbine blade assembly of any preceding clause, wherein the at least one pin has a teardrop, cross-sectional shape.

The turbine blade assembly of any preceding clause, wherein the teardrop, cross-sectional shape tapers in a direction from a junction of the cavity toward the diffuser outlet.

The turbine blade assembly of any preceding clause, wherein the at least one metering hole includes two metering holes that are on opposite sides of the at least one pin.

The turbine blade assembly of any preceding clause, wherein a cooling fluid flow exhausting from the cavity at the diffuser outlet comprises a set of flow components with directionalities that vary among at least 30 degrees relative to a common direction.

The turbine blade assembly of any preceding clause, wherein the airfoil includes a root, a tip, a leading edge, and a trailing edge, and wherein the cooling aperture is adjacent the tip and the trailing edge.

The turbine blade assembly of any preceding clause, further including a shank and a platform, the shank coupled to and extending from one side of the platform, the airfoil coupled to an extending from an opposite side of the platform.

The turbine blade assembly of any preceding clause, wherein the shank includes at least one inlet passage to provide the flow of cooling fluid to the airfoil.

A turbine blade assembly for a turbine engine, the turbine blade assembly comprising: an airfoil having outer wall defining an interior, the outer wall having an exterior surface and an interior surface; a cooling circuit in the interior to provide a flow of cooling fluid; and a cooling aperture in the outer wall, the cooling aperture comprising: a cavity at least partially defined between an inner surface and an outer surface, the cavity having a linear portion where the inner and outer surfaces are planar and parallel to each other; a first side partially defining the cavity; a second side partially defining the cavity, and meeting the first side at a junction, wherein a virtual plane is defined as extending through the junction spaced equidistant between the inner surface and the outer surface along the linear portion; a diffuser outlet exhausting from the cavity at the exterior surface, the diffuser outlet having a forward edge spaced from an aft edge, with the forward edge meeting the aft edge at a first end arranged at the first side and a second end arranged at the second side; a first axis defined extending between the junction and the first end; a first side axis defined as a projection of the first axis onto the virtual plane; a second axis defined extending between the junction and the second end; a second side axis defined as a projection of the second axis onto the virtual plane; a first curvature angle (γ_{A}) defined as an angle between the first axis and the first side axis, wherein the first curvature angle (γ_{A}) is 0.227 to 0.524 radians; and a second curvature angle (γ_{B}) defined as an angle between the second axis and the second side axis, wherein the second curvature angle (γ_{B}) is 0.227 to 0.524 radians, wherein

$$0.43 \leq ( \frac{{γ}_{A}}{{γ}_{B}} ) \leq 2.31 .$$

The turbine blade assembly of any preceding clause, further comprising at least one metering hole fluidly coupling the cooling aperture to the cooling circuit.

The turbine blade assembly of any preceding clause, wherein the at least one metering hole further comprises at least two metering holes.

The turbine blade assembly of any preceding clause, wherein the cooling aperture further comprises: a diffuser outlet length (lₑ) defined as a length measured along a curved line that is equidistant between the forward edge and the aft and extends between the first end and the second end of the diffuser outlet; and a diffuser outlet vector length (l_{e,v}) defined as a vector length measured between the first end and the second end; wherein

$$0.11 \leq ( \frac{{γ}_{A}}{{γ}_{B}} ) ( \frac{{l}_{e}}{{l}_{e , v}} ) \leq 12.78$$

The turbine blade assembly of any preceding clause, wherein the cooling fluid flow exhausting from the cavity at the diffuser outlet comprises a set of flow components with directionalities that vary among at least 30 degrees.

The turbine blade assembly of any preceding clause, wherein the cooling aperture further comprises a pin.

The turbine blade assembly of any preceding clause, wherein the pin extends between the inner surface and the outer surface.

The turbine blade assembly of any preceding clause, wherein the pin has a teardrop, cross-sectional shape.

The turbine blade assembly of any preceding clause, wherein the teardrop, cross-sectional shape tapers in a direction from the junction toward the diffuser outlet.

The turbine blade assembly of any preceding clause, wherein the cooling aperture includes two metering holes on opposite sides of the pin.

What is claimed is:

1. A turbine blade assembly for a gas turbine engine, the turbine blade assembly comprising:
an airfoil including an outer wall defining an interior, the outer wall having an interior surface facing the interior and an exterior surface opposite the interior surface;
a cooling circuit in the interior to provide a flow of cooling fluid; and
a cooling aperture in the outer wall and fluidly coupled to the cooling circuit, the cooling aperture comprising:
a cavity;
at least one metering hole that fluidly couples the cooling circuit and the cavity, with the at least one metering hole defining a longitudinal axis;
a diffuser outlet exhausting from the cavity at the exterior surface, the diffuser outlet having a forward edge spaced from an aft edge, the forward edge meeting the aft edge at a first end and a second end;
a metering hole area (A₁) of the cooling aperture is defined as the minimum cross-sectional area of the at least one metering hole when only one metering hole is present or a sum of the minimum cross-sectional areas of the at least one metering hole when multiple metering holes are present, wherein the metering hole area (A₁) is 0.051 to 0.456 millimeters squared (m²);
a diffuser outlet area (A₂) defined as an area of the diffuser outlet at the exterior surface of the airfoil, wherein the diffuser outlet area (A₂) is 0.129 to 4.000 mm²;
a diffuser outlet length (lₑ) defined as a length measured along a curved line that is equidistant between the forward edge and the aft edge and extends between the first end and the second end of the diffuser outlet, wherein the diffuser outlet length (lₑ) is 1.524 to 7.167 millimeters (mm); and
a diffuser outlet vector length (l_{e,v}) defined as a vector length measured extending between the first end and the second end of the diffuser outlet, wherein the diffuser outlet vector length (l_{e,v}) is 1.295 to 6.096 mm;
wherein
$$0.33 \leq ( \frac{{A}_{2}}{{A}_{1}} ) ( \frac{{l}_{e}}{{l}_{e , v}} ) \leq 92.21 .$$

2. The turbine blade assembly of claim 1,
wherein the cavity is defined by a first side and a second side meeting at a junction,
wherein a first axis extends from the junction to the first end of the diffuser outlet,
wherein a second axis extends from the junction to the second end of the diffuser outlet,
wherein a side angle (α) is defined as an angle between the first axis and the second axis, and
wherein
$$0.14 \leq ( \frac{{A}_{2}}{{A}_{1}} ) ( \frac{{l}_{e}}{{l}_{e , v}} ) ( \frac{1}{α} ) \leq 175.98 .$$

3. The turbine blade assembly of claim 1, further comprising at least one pin in the cavity, wherein the cavity is further defined between an inner surface and an outer surface, and wherein the at least one pin extends between the inner surface and the outer surface.

4. The turbine blade assembly of claim 3, wherein the at least one pin has a teardrop, cross-sectional shape.

5. The turbine blade assembly of claim 4, wherein the teardrop, cross-sectional shape tapers in a direction from a junction of the cavity toward the diffuser outlet.

6. The turbine blade assembly of claim 3, wherein the at least one metering hole includes two metering holes that are on opposite sides of the at least one pin.

7. The turbine blade assembly of claim 1, wherein a cooling fluid flow exhausting from the cavity at the diffuser outlet comprises a set of flow components with directionalities that vary among at least 30 degrees relative to a common direction.

8. The turbine blade assembly of claim 1, wherein the airfoil includes a root, a tip, a leading edge, and a trailing edge, and wherein the cooling aperture is adjacent the tip and the trailing edge.

9. The turbine blade assembly of claim 1, further including a shank and a platform, the shank coupled to and extending from one side of the platform, the airfoil coupled to an extending from an opposite side of the platform.

10. The turbine blade assembly of claim 9, wherein the shank includes at least one inlet passage to provide the flow of cooling fluid to the airfoil.

11. A turbine blade assembly for a turbine engine, the turbine blade assembly comprising:
an airfoil having outer wall defining an interior, the outer wall having an exterior surface and an interior surface;
a cooling circuit in the interior to provide a flow of cooling fluid; and
a cooling aperture in the outer wall, the cooling aperture comprising:
a cavity at least partially defined between an inner surface and an outer surface, the cavity having a linear portion where the inner and outer surfaces are planar and parallel to each other;
a first side partially defining the cavity;
a second side partially defining the cavity, and meeting the first side at a junction, wherein a virtual plane is defined as extending through the junction spaced equidistant between the inner surface and the outer surface along the linear portion;
a diffuser outlet exhausting from the cavity at the exterior surface, the diffuser outlet having a forward edge spaced from an aft edge, with the forward edge meeting the aft edge at a first end arranged at the first side and a second end arranged at the second side;
a first axis defined extending between the junction and the first end;
a first side axis defined as a projection of the first axis onto the virtual plane;
a second axis defined extending between the junction and the second end;
a second side axis defined as a projection of the second axis onto the virtual plane;
a first curvature angle (γ_{A}) defined as an angle between the first axis and the first side axis, wherein the first curvature angle (γ_{A}) is 0.227 to 0.524 radians; and
a second curvature angle (γ_{B}) defined as an angle between the second axis and the second side axis, wherein the second curvature angle (γ_{B}) is 0.227 to 0.524 radians,
wherein
$$0.43 \leq ( \frac{{γ}_{A}}{{γ}_{B}} ) \leq 2.31 .$$

12. The turbine blade assembly of claim 11, further comprising at least one metering hole fluidly coupling the cooling aperture to the cooling circuit.

13. The turbine blade assembly of claim 12, wherein the at least one metering hole further comprises at least two metering holes.

14. The turbine blade assembly of claim 11, wherein the cooling aperture further comprises:
a diffuser outlet length (lₑ) defined as a length measured along a curved line that is equidistant between the forward edge and the aft and extends between the first end and the second end of the diffuser outlet; and
a diffuser outlet vector length (l_{e,v}) defined as a vector length measured between the first end and the second end;
wherein
$$0.11 \leq ( \frac{{γ}_{A}}{{γ}_{B}} ) ( \frac{{l}_{e}}{{l}_{e , v}} ) \leq 12.78 .$$

15. The turbine blade assembly of claim 11, wherein the cooling fluid flow exhausting from the cavity at the diffuser outlet comprises a set of flow components with directionalities that vary among at least 30 degrees.

16. The turbine blade assembly of claim 11, wherein the cooling aperture further comprises a pin.

17. The turbine blade assembly of claim 16, wherein the pin extends between the inner surface and the outer surface.

18. The turbine blade assembly of claim 16, wherein the pin has a teardrop, cross-sectional shape.

19. The turbine blade assembly of claim 17, wherein the teardrop, cross-sectional shape tapers in a direction from the junction toward the diffuser outlet.

20. The turbine blade assembly of claim 16, wherein the cooling aperture includes two metering holes on opposite sides of the pin.
